(19) United States
(12) Patent Application Publication
(10) Pub. No.: US 2005/0074375 A1
(43) Pub. Date: Apr. 7, 2005

(54) Modular system for the treatment of process exhaust gases containing pollutants

(75) Inventors: Horst Reichardt, Dresden (DE); Andreas Frenzel, Dresden (DE); Konrad Gehmlich, Meissen (DE); Michael Wilde, Dresden (DE); Egbert Merforth, Dresden (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: DAS - Dunnschicht Anlagen Systeme GmbH, Dresden (DE)

(21) Appl. No.: 10/950,331

(22) Filed: Sep. 24, 2004

(30) Foreign Application Priority Data
Sep. 26, 2003 (DE) 103 46 284.8
Dec. 18, 2003 (DE) 103 60 355.7

(51) Int. Cl. B01D 50/00

(52) U.S. Cl. 422/182

(57) ABSTRACT

The invention relates to a modular system for the treatment of process exhaust gases containing pollutants. The object is to propose a possible way of carrying out the aftertreatment of process exhaust gases of this type which allows reliable operation at low cost. The intention is to allow sufficient redundancy and also flexible adaptation to increasing capacities to undergo aftertreatment. The modular system according to the invention is in this case designed in such a way that there is an electronic control for burners, the supply of process exhaust gases, washing liquid and/or of fuel gases in reaction chambers. At least two reaction chambers form modules which can be controlled by means of the electronic control for simultaneous or alternating treatment of process exhaust gases, taking account of detected operating states at the system or at least one module.

The invention relates to a modular system for the treatment of process exhaust gases containing pollutants. In such a system, process exhaust gases, such as those produced in a very wide range of surface modification technologies carried out under a vacuum, can be treated.

The exhaust gases produced in processes of this type are generally often laden with substances, which may also be toxic and which in particular cannot be discharged directly, without treatment, to atmosphere.

For the aftertreatment of process exhaust gases containing pollutants of this nature, it is customary to use installations and devices which separate the pollutants out of the corresponding process exhaust gases or convert them into other substances which no longer have the negative properties of the pollutants, or alternatively into substances which can be disposed of more easily in some other form, by means of a suitable treatment.

Examples of known devices of this type include gas scrubbers or plant engineering in which a thermal aftertreatment leads to conversion of the harmful substances. However, there are also combinations of the abovementioned installations.

Since the plant engineering for surface modification processes of this type carried out under a vacuum should be operated continuously, in particular for economic reasons, it is also intended to provide a continuous option for the aftertreatment of process exhaust gases of this type.

For this reason, it has hitherto been necessary to keep at least one entire installation in reserve in order to ensure the required redundancy. The actual design of an installation of this type corresponds at least to the one installation which is in any case required to maintain normal operation, and is designed for the same capacity. Accordingly, it includes all the components, as does the installation which is the absolute requirement. Accordingly, the costs of such installations are also identical.

The process installations used for the surface modification are often complex, comprising a plurality of components, i.e. a plurality of identical or different process chambers are connected to a central station for loading and unloading the substrates to be treated, and the process exhaust gases from these chambers are also discharged separately by vacuum pumps.

If a chamber is added to the process installation or if a chamber is modified, with an increase in the quantities of process exhaust gas, the operator is forced to invest in one or more complete conventional exhaust-gas disposal installations of this type.

Therefore, it is an object of the invention to propose a possibility for the aftertreatment of pollutant-containing process exhaust gases which, at low cost, can ensure the redundancy required for reliable operation and, once again in inexpensive form, allows flexible adaptation to increasing capacities which require aftertreatment.

According to the invention, this object is achieved by a modular system for the treatment of pollutant-containing process exhaust gases as defined by patent claim 1. Advantageous embodiments and refinements of the invention can be achieved by the features listed in the dependent claims.

The modular systems according to the invention for the treatment of process exhaust gases containing pollutants comprise at least two reaction chambers, which form modules, it being possible for further components to be present at the individual modules in addition to the reaction chambers.

The modules may be operated/controlled jointly or alternately, and this is done taking account of detected operating states at the modular system or at least one of the modules of a system.

For this purpose, sensors may be present for the detection of operating states.

Suitable sensors are temperature, volumetric flow, mass flow and/or pressure sensors.

Sensors of this type may be arranged in or at individual modules, it being possible to select an appropriate location for the sensors to be arranged by taking account of the particular physical measurement principle.

By way of example, it is possible to use temperature sensors in or outside reaction chambers for a thermal treatment. Then, temperature sensors of this type are used to detect, for example by means of a predetermined threshold value, whether, for example, burners at reaction chambers for a thermal treatment of process exhaust gases are in operation or a defect has occurred.

However, detection of this type can also be carried out externally using suitable optical detectors which are then designed as infrared sensors.

However, volumetric flow, mass flow and pressure sensors may also be arranged in feed lines for process exhaust gases, fuel gases and if appropriate also in feed lines for washing liquid.

The measurement signals from sensors can be used, via an electronic control, to influence the operation of an entire modular system and the individual modules of a system of this type.

For example, in a similar form to that which has already been discussed in connection with temperature sensors, if predetermined threshold values are exceeded or undershot by measurement signals from individual sensors, it is possible to generate control signals which, by way of example, cause a defective module to be switched off and operation to be switched over to another, functioning module of the system.

To relatively reliably ensure the redundancy required by operators of installations that produce process exhaust gases, it is advantageously possible, in a system formed from at least three, preferably four modules, to keep a module in reserve, to which operation can be switched if at least one of the other modules fails. During this phase, the aftertreatment of the process exhaust gases can then take place in this module until the module which has previously been switched off is once again fully functional.

However, an additional module of this type may also be manually switched on during periods in which cleaning and maintenance work needs to be carried out at one or more modules of a system.

With modular systems designed in this way, it is possible to achieve virtually 100% operational reliability for the aftertreatment of process exhaust gases at reduced costs.

It is advantageous for a module of this type, which ensures redundancy, to be provided with an increased capacity for the treatment of process exhaust gases. For example, a module of this type should have at least double the capacity of the treatment of process exhaust gases compared to the other modules of a system. Under extreme circumstances, the capacity of this one module may even be as high as the capacity of all the other modules of the system together.

It is advantageously possible for a single electronic control for the various components of the system which can be connected to the electronic control via interfaces to be present at a modular system according to the invention.

The individual modules of a system may be pure gas scrubbers, reaction chambers for the thermal treatment of the process exhaust gases or also combinations thereof and/or parts of modules.

For example, it is customary for a washing liquid also to be introduced into reaction chambers during a thermal treatment, in order to prevent deposits from adhering to the inner wall of the chamber and in order to allow particles contained in the process exhaust gas or formed during the thermal treatment to be discharged.

Accordingly, the feed for process exhaust gases, a washing liquid and/or a fuel gas for burners may be connected to the abovementioned electronic control. The supply of these media can then be the subject of open-loop, and if appropriate also closed-loop, control by means of the electronic control.

In the most simple case, the feedlines for the three abovementioned media leading to a module are simply opened or closed.

The modular system according to the invention may be designed in such a way that at least one second module can be connected to interfaces of the single electronic control, so that both modules can be actuated using the single electronic control.

In this case, the electronic control is arranged directly at one of the two modules and connected to it, i.e. it is an integral part of this one module, and the second module can, as it were, simply be put in place and connected to the electronic control.

However, it is also possible for the electronic control to be arranged separately from the individual modules of a modular system and for these modules to be connected to the interfaces of the electronic control in a corresponding way.

At least three or four modules should preferably be connected to an electric control.

In this case, it is favourable for the modules to be arranged in a row, and it is then also possible for a module to support the electronic control.

In addition to the one electronic control, functioning as a central electronic control for a plurality of modules, however, it is also possible for the feeds for the designated media process exhaust gas, washing liquid and/or fuel gas and further operating media, such as for example compressed air, nitrogen, lye, et al., to be effected in centralized form.

For example, it is possible for there to be a central feed for each one of the abovementioned media or also for all the abovementioned media at the modular system according to the invention, and for this central feed in turn to perform a distributor function for the respective media to the respective modules.

Central feeds of this type may be designed in such a way that at least one inlet for the respective medium opens out into a central feed, and a corresponding number of connections are present at the central feed, via which connections the central feed can be connected to the individual modules.

In this case, corresponding valves should be present in or at the central feed, but if appropriate also in connecting lines between the central feed and the individual modules, which valves can be opened or closed at least by means of the electronic control, so that the respective media can be fed to a module which at that time is to be operated for aftertreatment of process exhaust gases.

The abovementioned connections may then advantageously be positioned at central feeds in such a way that the particular arrangement of individual modules is also taken into account.

The valves which can be used for this purpose should advantageously be proportional valves with open-loop and/or closed-loop control, by means of which it is also possible to influence the respective volumes or mass flows of the media that can be fed to the respective modules.

If a washing liquid is to be introduced into modules, in a modular system according to the invention it is likewise advantageous for these modules to be connected to a central preparation station for the washing liquid. It is then possible, in a central preparation station of this type, for any solids which may be present in the washing liquid to be separated off or also for an additional chemical treatment to be carried out.

The washing liquid which has been prepared in the central preparation station can then be returned again; this should preferably take place at the central feed which has already been explained.

The operational reliability of the modular systems according to the invention may preferably be achieved by separate cycles for washing liquid for individual modules. However, it is also possible for a plurality of modules to be connected to a common cycle and for at least one module, which may preferably once again be the module for ensuring redundancy, to be connected to a separate cycle.

If there is no central preparation station, it is advantageous to reduce the consumption of media by washing liquid in the system being circulated and prepared.

The electronic control for a modular system according to the invention and/or a central feed may advantageously be arranged directly above the respective modules assigned to the system.

It is also possible for differently designed modules, which can each be used to carry out a different aftertreatment of process exhaust gases, to be arranged at a modular system according to the invention.

In this case, it is recommended for in each case pairs of identical modules to be provided at a modular system, in order to ensure the desired redundancy.

However, it is of course also possible to use a plurality of modular systems according to the invention.

The solution according to the invention allows the drawbacks which were mentioned in the introductory part of the description to be eliminated completely and in a simple way.

1. Modular system for the treatment of process exhaust gases containing pollutants, comprising an electronic control for burners, the supply of process exhaust gases, washing liquid and/or fuel gas in reaction chambers, wherein at least two reaction chambers form modules which are controlled by means of electronic control for simultaneous or alternating treatment of process exhaust gases, taking account of detected operating states at the system or at least one module.

2. System according to claim 1, wherein sensors for the detection of operating states are present at the system and/or the modules.

3. System according to claim 1, wherein the sensors are temperature, volumetric flow, mass flow and/or pressure sensors.

4. System according to claim 1, wherein, in the case of a system formed from at least three modules, one module is responsible for system redundancy by the system being switched over in the event of at least one of the other modules failing.

5. System according to claim 1, wherein all the modules of a system are identical in design.

6. System according to claim 1, wherein there are modules which are different from one another.

7. System according to claim 1, wherein one module of a system has at least double the capacity for the treatment of process exhaust gases compared to the other modules of the system.

8. System according to claim 1, wherein at least interfaces for the actuation of at least two separate modules are present at the electronic control, it being possible for at least one module to be connected to interfaces.

9. System according to claim 1, wherein the electronic control is arranged directly at a module and is connected to it.

10. System according to claim 1, wherein at least three modules can be connected to an electronic control.

11. System according to claim 1, wherein the modules are arranged in a row next to one another.

12. System according to claim 1, wherein there is a central feed for process exhaust gas, washing liquid and/or fuel gas with at least two connections for modules, and valves for opening and closing the connections are connected to the electronic control.

13. System according to claim 1, wherein the connections are arranged in a manner which takes account of the arrangement of modules.

14. System according to claim 1, wherein the valves are proportional valves with open-loop and/or closed-loop control.

15. System according to claim 1, wherein there is a central preparation station for the washing liquid, to which the modules can be connected.

16. System according to claim 1, wherein washing liquid which has been prepared again can be returned to modules.

17. System according to claim 1, wherein a return system for prepared washing liquid is connected to a central feed for washing liquid.

18. System according to claim 1, wherein washing liquid in the system has been circulated via a washing liquid treatment station.

19. System according to claim 18, wherein washing liquid is circulated separately in individual modules.

20. System according to claim 1, wherein sensors can be connected to interfaces of the electronic control.

21. System according to ms claim 1, wherein the electronic control and/or central feed is/are arranged above modules.

22. System according to claim 1, wherein there are reaction chambers for the thermal treatment of process exhaust gases.
